(19) United States
(12) Patent Application Publication
(10) Pub. No.: US 2016/0151906 A1
(43) Pub. Date: Jun. 2, 2016

(54) ASSEMBLY SUPPORTING DEVICE FOR SUPPORTING A TECHNICIAN DURING THE ASSEMBLY OF AN AIRPLANE FUSELAGE

(71) Applicant: Airbus Operations GmbH, Hamburg (DE)

(72) Inventors: Sven CHROMIK, Hamburg (DE); Robert Alexander GOEHLICH, Hamburg (DE)

(21) Appl. No.: 14/947,460

(22) Filed: Nov. 20, 2015

(30) Foreign Application Priority Data
Nov. 27, 2014 (DE) 102014117432.1

(51) Int. Cl. B25H 5/00; B65H 18/00; A41D 13/015; A41D 1/04; A41D 3/00; A47C 20/02; B64F 5/00

(52) U.S. Cl. CPC B25H 5/00; A47C 20/02; B65H 18/00; B64F 5/00; A41D 1/04; A41D 3/00; A41D 13/0155; A41D 2600/20

(57) ABSTRACT

The embodiment relates to an assembly supporting device for supporting a technician during the assembly of an aircraft or spacecraft. The assembly supporting device comprises a mat with a plurality of chambers filled with a gas. The assembly supporting device further comprises a sensor unit designed to determine a respective current gas pressure in the individual gas-filled chambers. A pressure regulating unit can be used to set the respective gas pressure in the individual chambers as a function of the current gas pressure determined in the respective chambers.

### CROSS-REFERENCE TO RELATED APPLICATIONS

This application claims the priority to German Patent Application No. 10 2014 117 432.1 filed 27 Nov. 2014, which is incorporated herein by reference in its entirety.

### TECHNICAL FIELD

The embodiments described herein relate to an assembly of an aircraft or spacecraft. In particular, the embodiment relates to an assembly supporting device for supporting a technician during the assembly of an aircraft or spacecraft, an assembly platform to which the assembly supporting device is secured, as well as an aircraft or spacecraft in which an assembly supporting device is secured. The embodiments further relates to a method for supporting a technician during the assembly of an aircraft or spacecraft.

### BACKGROUND

In addition, other objects, desirable features and characteristics will become apparent from the subsequent summary and detailed description, and the appended claims, taken in conjunction with the accompanying drawings and this background.

During the assembly of an airplane or airplane fuselage, a technician performs a plurality of working steps inside of the airplane fuselage. For example, such working steps encompass manufacturing rivet joints and screwed connections, or laying electrical or hydraulic supply lines. The technician may here be required to perform various working steps in hard-to-reach areas of the airplane fuselage. The assembly steps are here performed by the technicians with the use of different tools. The tools along with the components to be assembled are here brought into the airplane fuselage, where the components are then mounted to the airplane fuselage by means of the tools.

U.S. Pat. No. 8,266,778 B2 shows an assembly device for carrying a fuselage section of an airplane or spacecraft in an adjustable assembly position with at least one reinforcement bracket for detachably reinforcing the fuselage section and a pivot bearing that pivots the at least one reinforcement bracket.

US 2014/0145128 A1 shows a method for installing a cable harness in an airplane. The method uses cables, whose first ends are fastened to the cable harness, and winding devices. The cables are wound onto the winding devices, so that the cable harness can be lifted by applying a tensile force to the cables.

### SUMMARY

One embodiment relates to an assembly supporting device for supporting a technician during the assembly of an aircraft or spacecraft. Indicated in particular is an assembly supporting device for supporting a technician during the assembly of an aircraft fuselage or a spacecraft fuselage. The assembly supporting device exhibits a mat with a plurality of chambers filled with a gas. In addition, the assembly supporting device exhibits a sensor unit designed to determine a respective current gas pressure in the individual gas-filled chambers. The assembly supporting device also exhibits a pressure regulating unit designed to set the respective gas pressure in the individual chambers as a function of the current gas pressure determined in the respective chambers. The assembly supporting device is preferably designed to support a technician during the assembly of an aircraft fuselage or a spacecraft fuselage. In other words, the airplane fuselage can be part of the aircraft, or the spacecraft fuselage can be part of the spacecraft. In the following description, the assembly supporting device is described based on the example of an airplane fuselage, wherein the assembly supporting device can even be used generally for aircraft or spacecraft. For example, the aircraft can be an airplane, a helicopter or a drone. The spacecraft can here be a space shuttle, a launch vehicle, a booster of a launch vehicle, a satellite, a space station module or the like.

Such an assembly supporting device makes it possible to support a technician while mounting various components to the aircraft, i.e., to the airplane fuselage of the aircraft, during the assembly process. For example, such an assembly supporting device can be used for padding or cushioning a specific area of the airplane fuselage. The technician can here also support him or herself against the area of the aircraft fuselage padded by the mat, so that the level of comfort during assembly of the airplane fuselage can be enhanced. In particular, the technician can lie down on the mat during assembly, and thereby have various parts of his or her body supported. This may become necessary when hard-to-reach areas inside of the airplane fuselage are more readily accessible when in a reclined position, for example. This makes it possible to ensure an efficient assembly. In addition, the assembly time can be considerably shortened. For example, assembly here encompasses setting rivet joints, screwed connections and welded joints, or securing other components inside of the airplane fuselage. This also involves laying supply lines, for example hydraulic or electrical lines, inside of the airplane fuselage.

The mat can be made out of a flexible material. For example, the mat is made out of a plastic or elastomer. The mat can further exhibit a plurality of chambers, which are filled with a gas, for example air, and joined by way of supply lines with a pressure regulating unit in such a way that gas can be supplied to or removed from each of the individual chambers. In order to determine whether gas is to be supplied or removed, the sensor unit can determine a current gas pressure in each of the individual chambers. If a specific gas pressure is exceeded, for example given an elevated load on the chamber, additional gas is supplied to this chamber by the pressure regulating unit, so that the pressure in this chamber can be further elevated. For example, if the technician supports him or herself on the mat, in particular on a specific chamber, the pressure in the chamber supporting the technician increases. More gas can subsequently be supplied to this chamber, thereby ensuring that the technician can be more effectively supported on this chamber of the mat. For example, the individual chambers of the mat are arranged next to each other, i.e., in a checkerboard pattern. In other words, this means that the chambers are arranged next to each other in a first direction, and also arranged next to each other in a second direction running perpendicular to the first direction. The chambers thus repeat in a regular pattern, for example in both directions, so that a plurality of chambers arranged next to each other forms a row of chambers that runs parallel to another row of chambers. However, the chambers can also be tubular units, which together form the mat. If a chamber is exposed to less of a load, gas can again be removed from his chamber via the pressure regulating unit. For example, this happens when the gas pressure in an individual chamber drops below a specific level.

In an embodiment, the mat is designed for placement around the chest of the technician. For example, the mat is designed as a vest or jacket, which covers the upper body of the technician. As a consequence, the upper body or chest of the technician can be supported during assembly of the airplane fuselage, in particular in a reclined state, making it possible to enhance comfort during assembly. Therefore, the technician can get to hard-to-reach areas in the airplane fuselage during assembly even when lying down, and use both hands or arms in the process, since his or her hands are no longer required for support purposes. The pressure regulating unit of the assembly supporting device can be used to individually adjust the gas pressure in the respective chambers of the mat or vest wrapped around the chest of the technician to the posture or lying position of the technician. For example, the pressure is increased in those chambers located between a bearing surface of the airplane fuselage or an assembly platform and the technician him or herself. In particular, these are the chambers being acted upon by at least a portion of the body weight of the technician. By contrast, the gas pressure can be reduced in other chambers exposed to less of a load. For example, it is also possible for the pressure regulating unit to adjust the gas pressure as a function of the physiognomy of the technician, i.e., in a manner specific to the individual. As a result, the pressure regulating unit can also adjust the gas pressure to various body shapes of the technician.

Another embodiment indicates an assembly supporting device for supporting the technician during the assembly of an aircraft fuselage or a spacecraft fuselage. The assembly supporting device is here designed to support the technician during the assembly of an airplane fuselage, for example. For this reason, the characteristics and function of the assembly supporting device will be described below using the airplane fuselage as an example. The assembly supporting device exhibits a mat for padding a portion of the airplane fuselage. The assembly supporting device further exhibits a rolling device for automatically rolling up the mat, wherein the rolling device has a first fastening unit for attaching the rolling device to the airplane fuselage.

For example, the mat can be used to cushion a portion of the outer skin of the airplane inside of the airplane fuselage. As a consequence, the technician can lean against the outer skin of the airplane fuselage inside of the airplane fuselage, for example, wherein the mat is arranged between the outer skin of the airplane fuselage and the technician, and cushions the technician while leaning against the portion of the airplane fuselage, i.e., while leaning against the outer skin of the airplane, thereby providing efficient support to the technician while he or she performs the assembly steps. For example, the rolling device exhibits a spring element, which allows the mat to automatically roll up again. Therefore, the mat can only be rolled out by applying a force. When rolled up, the mat is wound up in the area of the rolling device. However, it is also possible for the mat to exhibit an elastic material. Various elastic materials can here also be provided, allowing the mat to automatically roll up as the result of inner stresses. For example, two opposing surfaces of the mat exhibit different elastic materials, which have varying elastic properties. Such a mat can also be envisaged as a kind of yoga mat. For example, the mat has a length of 2 to 2.5 m, and a width of 1 m to 1.5 m. The mat further has a thickness of 5 cm to 15 cm.

For example, the mat is attached to the airplane fuselage via the rolling device. This is enabled by the first fastening unit.

In an embodiment, the mat exhibits a plurality of chambers filled with a gas, wherein a respectively prevailing gas pressure can be set in the individual chambers. For example, the chambers can be designed as air cushions or tubes. The chambers can further be arranged in a checkerboard pattern. In other words, this means that the chambers are arranged next to each other in a first direction, and also arranged next to each other in a second direction running perpendicular to the first direction. The chambers thus repeat in a regular pattern, for example in both directions, so that a plurality of chambers arranged next to each other forms a row of chambers that runs parallel to another row of chambers. The gas pressure inside of the chambers can be adjusted in such a way as to supply additional gas to chambers exposed to a high load, and remove gas from chambers exposed to less of a load. For example, if the technician leans against the mat that cushions the portion of the airplane fuselage, those chambers against which the technician leans or upon which the technician lies can be filled with more air, thereby ensuring a comfortable posture of the technician during assembly. For example, the pressure regulating unit can be used to elevate the gas pressure in those chambers that support the technician, while gas can be removed from those chambers not exposed to any load, e.g., from supporting the technician, thereby diminishing the gas pressure in these chambers.

In another embodiment, the rolling device is secured to a first end of the mat, and a second fastening device is arranged on a second end of the mat. The first fastening device can be designed to join the rolling device with the airplane fuselage or attach the rolling device to the airplane fuselage and/or attach the mat to the rolling device. It can here be provided that the rolling device not change its position relative to the fuselage when the mat is rolled in or out. In particular, the mat can be fastened to an assembly platform. Therefore, it can be provided that only the second fastening unit can be moved in the area of the second end of the mat relative to the airplane fuselage. For example, the second fastening unit or a corresponding device on the second end of the mat can be suitable for moving the mat from a rolled up state into an unrolled state. This can be achieved with a handle at the second end of the mat, for example, which the technician can use to roll out the mat.

In another embodiment, the mat can be secured to the aircraft or spacecraft by means of the second fastening unit in such a way that the mat remains in a rolled out state. In particular, the mat can be attached to the airplane fuselage with the second fastening unit in such a way that the mat remains in a rolled out state.

This makes it possible to fix the mat in place relative to the airplane fuselage after the mat has been rolled out by the technician. For example, a latching mechanism can be provided as the second fastening unit, with which the mat can be secured in such a way as to remain in the rolled out state. However, the second fastening unit can also be designed to engage into a corresponding counter-piece on the airplane fuselage. For example, the second fastening unit can be suspended in the counter-piece, e.g., which takes the form of a hook. To this end, the second fastening unit can be designed as a ring or clamp.

In another embodiment, the rolling device automatically rolls up the mat after the mat secured by the second fastening unit to the aircraft or spacecraft, in particular to the airplane fuselage, has been detached.

For example, if the second fastening unit is uncoupled or unlatched from the counter-piece on the airplane fuselage, the rolling device automatically rolls up. The automatic rollup can be achieved by a providing a corresponding elastic material or arranging elastic materials inside of the mat, for example. However, the mat can also be reinforced by reinforcing elements, which cause the mat to be rolled up after the attachment established by the second fastening unit has been released. When in the rolled-up state, the mat is wound up in the area of the rolling device. The mat can only be rolled out again via the application of a force, e.g., by the technician.

Another aspect of the embodiment provides an assembly platform, upon which is secured an assembly supporting device for supporting a technician during the assembly of an aircraft or spacecraft. Preferably indicated is an assembly platform, upon which is secured an assembly supporting device for supporting a technician during the assembly of an airplane fuselage.

For example, the assembly platform is a wood structure. The assembly platform is a carrying device, for example, consisting of aluminum or an aluminum alloy. The assembly platform can exhibit a flat plate supported by two beams or several pillars. The pillars are here detachably secured to the fuselage structure of the airplane fuselage. In particular, the assembly platform can be a construction specially configured for an airplane fuselage, which is only secured in the airplane fuselage during assembly. In any event, the flat plate is suitable for bearing the weight of at least one technician and/or various tools. The assembly platform can be comprised of at least one wood pallet. For example, the wood structure or wood pallet is fastened to the floor of the airplane fuselage inside of a cargo loading area. The rolling device is in turn secured to the assembly platform, for example, i.e., to the wood structure or wood plate. As a consequence, the rolling device can simply be removed from the airplane fuselage along with the assembly platform after assembly.

In another aspect the embodiment provides an aircraft or spacecraft, which incorporates an assembly supporting device for supporting a technician during the assembly of an airplane fuselage.

Another aspect of the embodiment provides an airplane fuselage, which incorporates an assembly supporting device for supporting a technician during the assembly of an airplane fuselage.

For example, the airplane fuselage exhibits an outer skin along with various reinforcing elements, such as frames or stringers. In addition, the airplane fuselage can exhibit a floor, upon which the assembly platform can be secured.

In an embodiment, the rolling device is arranged in the airplane fuselage in such a way that the mat can be rolled out and in in a direction essentially perpendicular to a longitudinal axis of the airplane fuselage.

The longitudinal axis of the airplane fuselage, for example one having a cylindrical design, can here essentially run parallel to a shell surface of the cylindrical airplane fuselage. The process of rolling out or rolling in the mat can take place in the circumferential direction of the cylindrical shell surface of the airplane fuselage, for example. As a result, the mat can adjust or adapt to a contour of the airplane fuselage while being rolled out. For example, the contour is here defined by the outer skin of the airplane fuselage.

In another embodiment, the mat is secured in a cargo sector of the airplane fuselage. For example, the rolling device here secures the mat in the cargo sector of the airplane fuselage or to an assembly platform in the cargo sector of the airplane fuselage. The cargo sector inside of the airplane fuselage is situated underneath a main passenger cabin. The assembly supporting device ensures that the technician will be able to comfortably mount various components to the aircraft fuselage. For example, the technician can perform various working steps in a lying position, in which the technician lies down on the mat or leans against the mat.

Another aspect of the embodiment indicates a method for supporting a technician during the assembly of an aircraft or spacecraft. Indicated in particular is a method for supporting a technician during the assembly of an airplane fuselage. In one step of the method, a mat with a plurality of chambers filled with a gas is provided. In another step, a respective current gas pressure in the individual gas-filled chambers is determined with a sensor unit. In a further step, the respective gas pressure in the individual chambers is set as a function of the current gas pressure determined in the respective chambers. In a further step, for example, a portion of the airplane fuselage is cushioned by the mat.

For example, this cushioning makes it possible to enhance the comfort of the technician during the assembly of the airplane fuselage.

### BRIEF DESCRIPTION OF THE DRAWINGS

The various embodiments will hereinafter be described in conjunction with the following drawing figures, wherein like numerals denote like elements, and:

Exemplary embodiments will be described below, drawing reference to the following figures.

FIG. 1 shows an assembly supporting device with an at least partially rolled up mat and a rolling device according to an exemplary embodiment.

FIG. 2 shows a portion of an aircraft fuselage with an assembly supporting device, which is secured to an assembly platform, according to an exemplary embodiment.

FIG. 3 shows a portion of an aircraft fuselage with an assembly supporting device, which is secured to an assembly platform, according to another exemplary embodiment.

FIG. 4 shows a detailed view of a fastening unit for a mat according to an exemplary embodiment.

FIG. 5 shows a portion of an aircraft fuselage with an assembly supporting device, which is secured to an assembly platform, according to another exemplary embodiment.

FIG. 6 shows an assembly supporting device in the form of a vest for a technician according to an exemplary embodiment.

FIG. 7 shows an assembly supporting device in the form of a vest for a technician according to another exemplary embodiment.

FIG. 8 shows a portion of an airplane fuselage, in which technicians with an assembly supporting device are located, according to an exemplary embodiment.

FIG. 9 shows a flowchart of a method for supporting a technician during the assembly of an airplane fuselage according to an exemplary embodiment.

### DETAILED DESCRIPTION

The following detailed description is merely exemplary in nature and is not intended to limit the disclosed embodiments or the application and uses thereof. Furthermore, there is no intention to be bound by any theory presented in the preceding background detailed description.

If the same reference numbers are used in various figures in the following description to the figures, the latter denote identical or similar elements. Identical or similar elements can also be marked with different reference numbers, however.

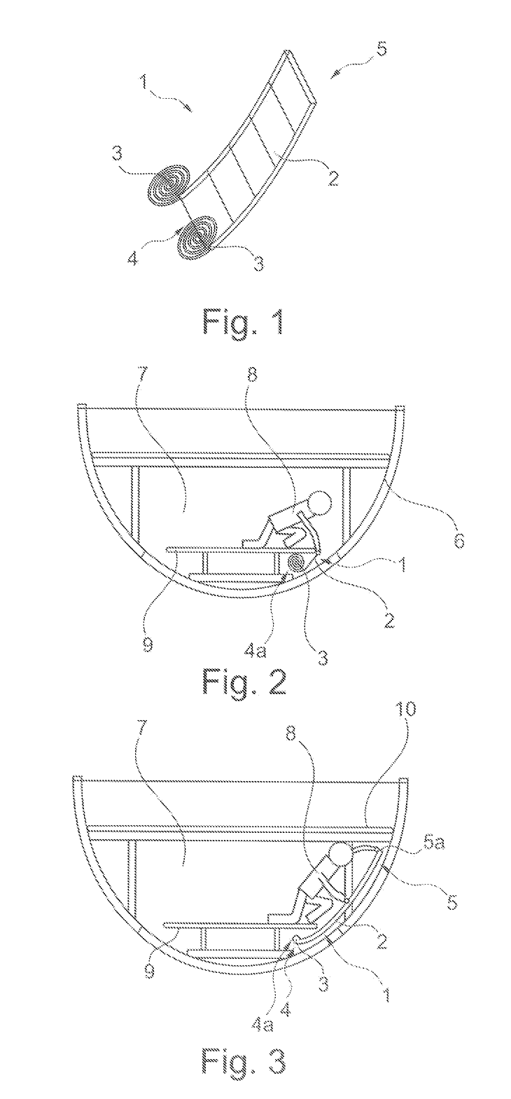

FIG. 1 shows an assembly supporting device 1 with a mat 2 and a rolling device 3. The mat 2 is depicted in an at least partially rolled up state. The mat 2 is here at least partially rolled up or wound onto the rolling device 3. To this end, for example, the rolling device 3 exhibits a spring positioned in such a way that the mat 2 is automatically rolled up onto the rolling device 3. The mat 2 can also be made to automatically roll up by placing various elastic materials inside of the mat 2 or on the mat 2. For example, a first surface of the mat 2 exhibits an elasticity that differs from another elasticity of a second surface of the mat 2. As a consequence, it can always be ensured that the mat 2 will be automatically rolled up on the rolling device 3. In other words, the mat 2 can only be rolled out via the application of a force, for example by the technician. The mat 2 is rigidly joined to a first end 4 with the rolling device 3. The mat 2 can further be rolled out via the application of a force to a second end 5, for example by the technician. The mat 2 can exhibit various chambers, which are each filled with a gas. A pressure regulating unit can here supply or remove air to and from the individual chambers of the mat 2, depending on the load placed on the mat 2. As a result, the pressure in the individual chambers of the mat 2 can be set by the pressure regulating unit. In addition, the gas pressure in each of the chambers is measured with a sensor unit.

FIG. 2 shows a portion of the airplane fuselage with an assembly supporting device 1, wherein the assembly supporting device 1 is secured to an assembly platform 9 inside of the airplane fuselage. The rolling device 3 of the assembly supporting device 1 is here attached to the assembly platform 9 by means of a first fastening unit 4a. FIG. 2 further depicts a technician 8, who pulls on a second end 5 of the mat 2 of the assembly supporting device 1 to bring the mat 2 into a rolled-out state. In the case shown on FIG. 2, however, the mat 2 is still wound on the rolling device 3 for the most part. The assembly supporting device is designed to support the technician 8 during the assembly of various components inside of the airplane fuselage, for example in a cargo sector 7 of the airplane fuselage. For example, the technician 8 performs different working steps or assembly steps on the outer skin 6 of the airplane fuselage. Prior to assembly, the technician 8 brings the assembly supporting device 1 into a rolled out state by rolling out the mat 2, so as to thereby enhance the comfort level for the working steps to come, i.e., assembling the components inside of the airplane fuselage. Examples of such components include clamps, rivets, screws, cable lines, supply lines or other structural components of the airplane fuselage.

FIG. 3 shows a portion of an airplane fuselage with an assembly supporting device 1. The mat 2 of the assembly supporting device 1 is here in a rolled-out state. This state can be achieved through the application of a force, for example by the technician 8. The technician 8 here pulls the mat 2 by a second end 5 of the mat 2, so that the mat 2 can be attached to the airplane fuselage by means of a second fastening unit 5a. By attaching the mat 2 with the second fastening unit 5a, the mat 2 can be made to stay in the rolled out state. For example, this is achieved by suspending the second end 5 of the mat 2 from a hook, which is secured to the airplane fuselage. As a consequence, the mat 2 is fixed relative to the airplane fuselage by the first fastening unit 4a and second fastening unit 5a so that it can adjust to a contour of the airplane fuselage, e.g., the outer skin of the airplane. The mat 2 can here take on a curved shape. For example, the technician 8 can lean against the mat 2, and thus be comfortably supported while performing assembly work inside of the airplane fuselage. This is advantageous in particular when assembly steps are to be completed in hard-to-reach areas inside of the airplane fuselage. For example, assembly inside of a cargo sector 7, which is limited in terms of height, can be made easier. In other words, the technician 8 can perform the required assembly steps inside of the airplane fuselage while positioned lying on the mat 2 or leaning on the mat 2. This is especially advantageous, since cargo sectors 7 can be limited in terms of their height, so that lying down during assembly makes it easier for the technician 8. In addition, the technician 8 can more easily change his or her working position from time to time. For example, the cargo sector 7 is limited in terms of its height by a floor plate 10 of the passenger cabin.

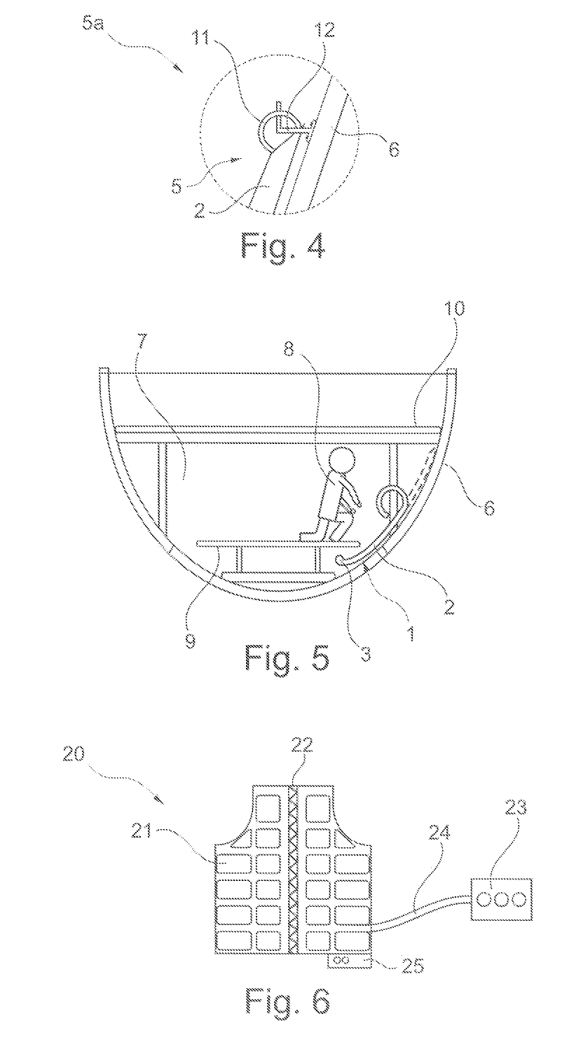

FIG. 4 shows a detailed view of the second fastening unit 5a, with which the mat 2 can be attached to the airplane fuselage by the second end 5. For example, the second end 5 of the mat 2 is here fixed to an outer fuselage skin 6 or to a reinforcing element of the outer fuselage skin 6. This can be done with a ring 11 secured to the mat 2 by suspending it in a hook 12 fastened to the outer fuselage skin 6 or to a reinforcing element of the outer fuselage skin 6, for example. However, other fastening methods are also possible. For example, this can also be a latching mechanism, for which a vertical adjustment is conceivable. In other words, the surface of the rolled-out mat 2 can be variably set, for example by attaching the mat 2 in different positions of the outer fuselage skin 6 with the second fastening unit 5a of the mat 2.

FIG. 5 shows a portion of the airplane fuselage with an assembly supporting device 1. The assembly supporting device 1 is here arranged inside of the airplane fuselage in such a way that the rolling device 3 can be attached to the assembly platform 9 and/or to the airplane fuselage itself. The example depicted on FIG. 5 does not show how the rolling device 3 is attached by means of the first fastening unit 4a. FIG. 5 presents the mat 2 in a partially rolled-out state, which denotes the progression of the mat 2 with solid lines. Also depicted is a rolled-out state of the mat 2, whose progression is represented by dashed lines. In particular, it is provided that the mat 2 can be brought into the rolled-up state without any action on the part of the technician 8. However, the technician 8 must apply a force to move the mat into the rolled-out state. The mat 2 is designed in such a way as to adjust or adapt to the contour of the outer skin 6 of the fuselage, and thereby cushion a section along the contour of the outer fuselage skin 6 inside of the airplane fuselage. For example, the assembly supporting device 1 can be situated inside of the airplane fuselage underneath a floor construction or floor plate 10 of a main passenger cabin. In other words, the assembly supporting device 1 is arranged in a cargo sector 7 of an airplane fuselage. In the case illustrated on FIG. 5, the rolling device 3 is attached to the airplane fuselage and/or to the assembly platform 9 by the first fastening unit 4a. However, it can also be provided that the rolling device 3 be secured in the cargo sector 7 in the area of the floor plate 10. This makes it possible to roll out the mat 2 oppositely to how the mat 2 is rolled out on FIG. 5. The second end 5 of the mat can here be attached in the area of a floor plate of the cargo sector 7, or in the area of the assembly platform, wherein the second fastening unit 5a is used for attachment purposes.

FIG. 6 shows an assembly supporting device in the form of a vest 20 for a technician 8. The vest 20 exhibits a zipper 22, so that the technician 8 can put the vest 20 around his or her chest and close it. The vest 20 is designed as a mat 2, which exhibits different chambers 21 filled with air. A respective current gas pressure can be measured in these air-filled chambers 21 with a sensor unit 25. An air supply unit 24 can further be used to separately supply air to or remove air from each of the individual chambers 21. Provided for this purpose is a pressure regulating unit 23, which supplies air to or removes air from individual chambers 21 via the air supply unit 24. For example, the supply or removal of air can here take place as a function of the current pressure measured in the individual chambers 21 by the sensor unit 25. For example, the pressure is increased by supplying air via the air supply unit 24 in those chambers 21 in which a specific current gas pressure value has been exceeded. This is the case, for example, when the technician 8 is only lying on specific chambers 21 with the vest 20 wrapped around his or her body. Consequently, the air supply unit 24 can individually fill these chambers 21 exposed to a higher load with additional air. Correspondingly, the air supply unit 24 can likewise be used to remove air from chambers 21 exposed to less of a load. For example, the chambers 21 are arranged in a checkerboard pattern over the surface of the mat 2 or vest 20. The individual chambers 21 are here joined together by sections that are either filled with no air or less air than the chambers 21 themselves, for example.

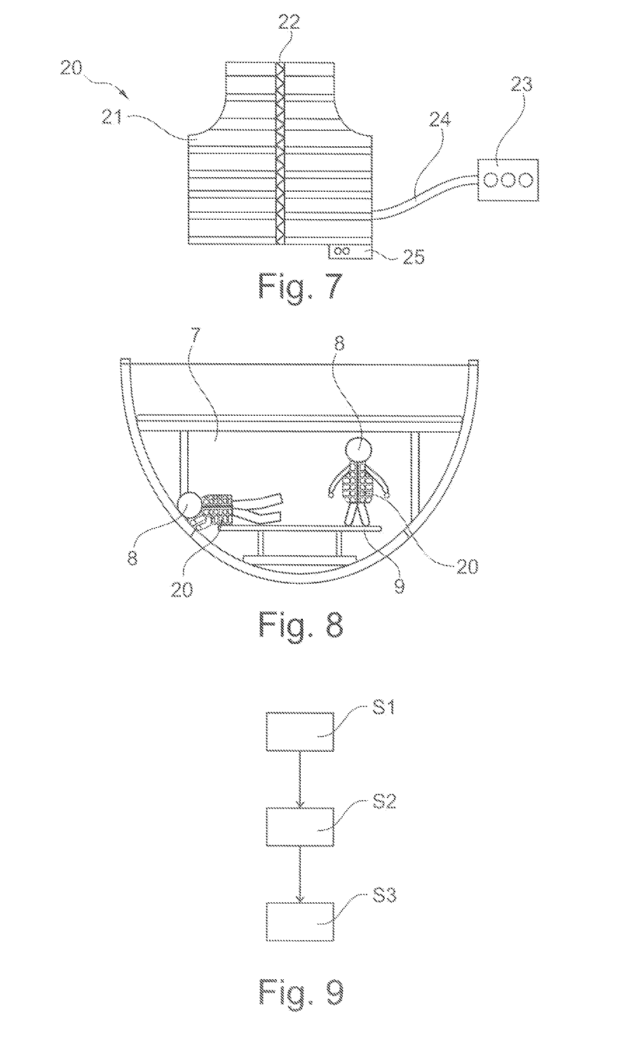

FIG. 7 shows another example of an assembly supporting device 1 in the form of a vest 20. A zipper 22 is here also provided, so that the technician 8 can place the vest over his or her upper body and close it. Further provided once again are a pressure regulating unit 23 and an air supply unit 24, which can be used to supply individual chambers 21 of the vest 20 with air. As opposed to the example depicted on FIG. 6, however, the individual chambers 21 are arranged in a tubular pattern over the entire width of the mat 2 or vest 20. However, the tubular chambers 21 can also be arranged perpendicular to the exemplary embodiment shown on FIG. 7, so that the tubular chambers 21 run over the entire height of the vest 20, or at least partially over the entire height of the vest 20. As a result, the technician can be laterally stabilized while lying down. In particular, varying the pressure levels in different chambers 21 can tilt the body of the technician 8 to the side. It can be provided that the technician 8 does not have to use his or her arms to turn his or her body at all when lying down, since the body is turned by increasing or decreasing the pressure in the chambers 21 in a targeted fashion. Once again situated between the tubular chambers 21 are respective sections in which less or no air is present. The gas pressure or air pressure in the individual chambers 21 can be set as a function of the respective load placed on the individual chambers 21, i.e., as a function of the pressures in the individual chambers 21 currently measured by the sensor unit 25. This is accomplished with the pressure regulating unit 23 or the air supply unit 24.

FIG. 8 shows a portion of the airplane fuselage, in which technicians 8 make use of the assembly supporting device or vest 20. For example, the technicians 8 here perform different assembly steps inside of the cargo sector 7 of the airplane fuselage. The technician 8 can here perform working steps while lying down, for example on the assembly platform 9, while at the same time being cushioned or supported by the vest 20, i.e., the mat 2. This increases the level of comfort for the technician 8 while carrying out the working steps. In the state depicted on FIG. 8, the upper body of the technician 8 is covered by the vest. The lying position of the technician 8 increases the pressure inside of the individual chambers 21 of the vest 20, so that a pressure regulating unit 23 can be used to adjust the pressure in the individual chambers 21 of the vest 20. In other words, the individual chambers 21 are inflated to more or less of an extent, depending on the load, i.e., the pressure load. The necessary compressed air can be provided by an air supply unit 24, which is situated inside of the airplane fuselage anyway during assembly. To this end, for example, use can be made of compressed air from a compressed air tube, which also supplies various tools with compressed air in the assembly process. However, a mobile compressed air bottle can also be provided, which supplies the individual chambers 21 with compressed air. Likewise, an electric pump can also be provided for supplying compressed air to the chambers 21 of the mat 2 or vest 20.

FIG. 9 shows a flowchart of a method for supporting a technician 8 during the assembly of an airplane fuselage. In one step S1 of the method, a mat 2 with a plurality of chambers 21 filled with a gas is provided. In a further step S3 of the method, a respective current gas pressure in the individual gas-filled chambers 21 is determined with a sensor unit 25. In another step S4, the respective gas pressure in the individual chambers 21 is set as a function of the current gas pressure determined in the respective chambers 21.

Let it also be noted that the procedural steps of the described method can be performed in any sequence desired.

Furthermore, it must be emphasized that “comprising”, “exhibiting” and “encompassing” does not preclude any other elements or steps, and that “a” or “an” do not rule out a plurality. Let it also be emphasized that features or steps described with reference to one of the above exemplary embodiments can also be used in combination with other features or steps from other exemplary embodiments described above. Reference numbers in the claims are not to be construed as a limitation.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

1. An assembly supporting device configured to support a technician during the assembly of an aircraft or spacecraft, comprising:
a mat with a plurality of chambers filled with a gas;
a sensor unit configured to determine a respective current gas pressure in the individual gas-filled chambers; and
a pressure regulating unit configured to set the respective gas pressure in the individual chambers as a function of the current gas pressure determined in the respective chambers.

2. The assembly supporting device of claim 1,
wherein the mat is configured for placement around the chest of the technician.

3. An assembly supporting device for supporting a technician during the assembly of an aircraft or spacecraft, exhibiting:
a mat for cushioning a portion of the aircraft or spacecraft;
a rolling device for automatically rolling up the mat;
wherein the rolling device comprises a first fastening unit for attaching the rolling device to the aircraft or spacecraft.

4. The assembly supporting device of claim 3, wherein the mat comprises:
a plurality of chambers filled with a gas;
wherein a respectively prevailing gas pressure can be set in the individual chambers.

5. The assembly supporting device of one of claim 4,
wherein the rolling device is secured to a first end of the mat, and a second fastening unit is arranged on a second end of the mat.

6. The assembly supporting device of claim 5,
wherein the mat is configured to be secured to the aircraft or spacecraft by means of the second fastening unit in such a way that the mat remains in a rolled out state.

7. The assembly supporting device of claim 6,
wherein the rolling device automatically rolls up the mat after the ma secured by the second fastening unit to the aircraft or spacecraft has been detached.

8. An assembly platform, upon which is secured an assembly supporting device of one of claim 7.

9. (canceled)

10. An aircraft or spacecraft, comprising:
a rolling device configured to automatically roll up the mat;
wherein the rolling device comprises a first fastening unit configured to attach the rolling device to the aircraft or spacecraft.

11. The aircraft or spacecraft of one of claim 10,
wherein the mat is secured in a cargo sector of the aircraft or spacecraft.

12. (canceled)

13. The assembly supporting device of claim 3
wherein the rolling device is secured to a first end of the mat, and a second fastening unit is arranged on a second end of the mat.
